(19) United States
(12) Patent Application Publication
(10) Pub. No.: US 2026/0201955 A1
(43) Pub. Date: Jul. 16, 2026

(54) SEAL ARRANGEMENT

(71) Applicant: Schaeffler Technologies AG & Co. KG, Herzogenaurach (DE)

(72) Inventors: Marco Krapf, Burkardroth (DE); Patrick Schmitt, Gerolzhofen (DE); Andreas Becker, Fuchsstadt (DE)

(73) Assignee: Schaeffler Technologies AG & Co. KG, Herzogenaurach (DE)

(21) Appl. No.: 19/134,210

(22) PCT Filed: Nov. 9, 2023
(86) PCT No.: PCT/DE2023/100848

§ 371 Date: May 30, 2025

(30) Foreign Application Priority Data
Dec. 1, 2022 (DE) 10 2022 131 855.9

(51) Int. Cl. F16J 15/3284; F16C 33/78; F16J 15/3204

(52) U.S. Cl. CPC F16J 15/3284; F16C 33/7863; F16C 33/7866; F16J 15/3204; F16C 2208/02; F16C 2208/10

(57) ABSTRACT

The disclosure relates to a seal arrangement with a sealing element, which has a carrier plate with a sealing body of an elastomer material molded onto it. The sealing body has at least a first sealing lip. The elastomer material of the sealing body is provided with fillers arranged at least in regions thereof, and the elastomer material has at least a first filler and a second filler, different from the first filler. Particles at least of one of the fillers have a greater hardness than the elastomer material of the sealing body.

### CROSS-REFERENCE TO RELATED APPLICATIONS

This application is the U.S. National Phase of PCT Application No. PCT/DE2023/100848 filed on Nov. 9, 2023, which claims priority to DE 10 2022 131 855.9 filed on Dec. 1, 2022, the entire disclosures of which are incorporated by reference herein.

### TECHNICAL FIELD

The disclosure relates to a seal arrangement usable in a wide variety of applications, for example, in a bearing, such as a wheel bearing, wind turbines, e-mobility applications, agricultural machinery, processing machines or in all applications in which dynamic seals are used.

### BACKGROUND

DE 10 2018 132 388 A1 discloses a seal with an elastomer body. The elastomer body has a special filler mixture at least in sections. The elastomer body consists, for example, of a vulcanized elastomer mixture or a thermoplastic elastomer that contains fillers as a filler mixture. One example of this is the use of PTFE as a friction-reducing substance, which is used as a filler in seals. However, this has the disadvantage that a high level of abrasion is created on the seal due to its rather soft surface and self-lubricating properties.

### SUMMARY

The object of the present disclosure is to propose a sealing element and a bearing arrangement with improved friction properties, in particular lower friction losses in the sealing lip contact, wherein the abrasion of the seal should also be positively influenced.

A seal arrangement according to the disclosure has a sealing element which has a carrier with a sealing body molded thereon of an elastomer material, wherein the sealing body has at least a first sealing lip, wherein the elastomer material of the sealing body is provided with fillers arranged therein at least in regions, wherein the elastomer material has at least a first filler and a second filler different from the first filler, wherein particles of at least one of the fillers have a higher hardness than the elastomer material of the sealing body.

The carrier can, for example, be a carrier plate made of a metallic material. Alternatively, the carrier can also be made of a plastic or fiber composite or the like.

By adding a combination of at least two different fillers, both the friction on the seal and the abrasion on the seal can be reduced. The filler with higher hardness makes the seal more durable. Suitable fillers for the first or second filler can be: glasses, carbon, graphite, basalt, phenolic resin and PTFE. The addition of other friction-reducing fillers, such as molybdenum disulfide, aramid or bronze, is also conceivable.

The elastomer material of the sealing body, in particular at least the first sealing lip, is enriched with fillers consisting of a plurality of fine particles, fibers or powders, at least in regions or sections, using a suitable manufacturing method. In an example embodiment, the entire seal contains fillers.

In principle, any basic elastomer material is suitable for the sealing body. Nitrile rubber, such as NBR (nitrile butadiene rubber), is particularly suitable. Also conceivable are HNBR (hydrogenated nitrile butadiene rubber), FKM (fluorocarbon rubber), ACM (polyacrylate copolymer), EPDM (ethylene propylene diene (monomer) rubber) or the like. Thermoplastic elastomers, such as TPE, TPU, TPA, etc., or even blends of the above-mentioned materials could also be used.

In the mixing process of the elastomer material, also referred to as matrix compound, the fillers can be added to the mixture in a simple manner so that further manufacturing or processing steps of one or more components of the sealing element are not necessary. The elastomer mixture can also be used in a seal arrangement that contains a surface-modified counter-running surface, which can be expected to reduce friction even further. In principle, the fillers can be made of materials that have a higher hardness than the elastomer material, also referred to as matrix compound. However, it is also possible to mix hard fillers with softer, friction-reducing fillers.

In an example embodiment, the first filler is made of carbon, such as carbon fibers, carbon fiber fragments or carbon fiber particles. It is also conceivable that barium sulfate could be used as a filler. By adding comparatively hard fillers such as carbon fiber, phenolic resin and the like, the abrasion resistance of the seal can be increased and the surface microstructure can also be positively influenced. Friction is reduced by the presence of the fillers directly in the friction contact, where they reduce the friction of the seal due to their high hardness and lower friction compared to rubber.

In an example embodiment, the second filler is made of a PTFE micropowder, a glass powder and/or a phenolic resin, or a combination thereof. The use of barium sulfate, in particular with a size in the range between 30 and 500 μm, as a second filler would also be conceivable. By adding these fillers to the elastomer material, the friction of the seal can be further reduced.

In an example embodiment, the particles of the filler variants, i.e., the first or second fillers, are softer than the material of the counter-running surface. Fillers with such particles are made in particular of carbon or plastic, such as PTFE, carbon fiber, thermoplastics or resins. This has the advantage that if the fillers are released from the elastomer material due to abrasion or the like, they do not damage the component to be sealed or the bearing unit.

In an example embodiment, the elastomer material of the seal is provided with particles of a third filler. The third friction-reducing filler can be formed from a glass powder and/or a phenolic resin. The elastomer material can be made of a vulcanized rubber. The vulcanized rubber can be nitrile rubber (NBR), acrylate rubber (ACM) or fluoro-rubber (FKM), for example. A combination of NBR as the elastomer material with carbon fibers as the first filler, PTFE micropowder as the second filler and glass powder as the third filler can be used in this context.

In an example embodiment, the particles of the first filler and the particles of the second filler have different geometric shapes. The particles of the first filler can be spherical or ellipsoidal and the particles of the second filler are fibrous or vice versa and the particles of the third filler are pulverulent. However, the same filler can also be mixed in different geometric shapes. It would also be conceivable for the first filler, the second filler and the third filler to have the same geometric shape. This can occur, for example, when using glass powder or carbon fiber powder as a filler.

In principle, the filler particles can have any shape or structure. An ellipsoidal, spherical and/or fibrous shape of the filler particles has proven to be advantageous. In other words, the fillers are ellipsoidal, spherical and/or fibrous particles. One advantage of spherical or ellipsoidal filler particles is that the fillers can be distributed very evenly in the elastomer material. Fibrous filler particles can additionally mechanically reinforce the elastomer material. A combination of FKM as an elastomer material with spherical or fibrous fillers has particularly good friction properties. Irregular particles, i.e., particles with an irregular shape, have the advantage that they interlock better with the polymer matrix than round particles and can therefore effect a better adhesion in the matrix. With regard to improved embedding in the elastomer, fibrous fillers can be used. In addition, fillers can also be provided with a special surface treatment, such as sizing, surface activation or functional groups. The particles can therefore be designed to be both regularly and irregularly spherical or ellipsoidal or the like.

At least some of the spherical, ellipsoidal and/or fibrous filler particles can accumulate on the surface of the sealing body, in particular of the at least first sealing lip, during manufacture of the sealing body. These can either protrude from the surface and be embedded in the elastomer material at the same time, or they can be covered by a thin elastomer layer. In the latter case, the elastomer stretches over the filler particles arranged on the surface as the elastomer cross-links and shrinks during manufacture. In both cases, the fillers structure the surface of at least the first sealing lip. In this way, the friction losses on the surface of the sealing body or in the contact region of the sealing body with the running plate can be significantly reduced, wherein the sealing effect is not impaired. As the seal wears, the particles are exposed and reduce friction due to their higher hardness and possibly additional friction-reducing or self-lubricating properties.

For spherical or ellipsoidal particles, phenolic resin beads, glass beads, hollow glass beads, PE or HDPE beads with a diameter range of 5 μm to 200 μm are particularly suitable. Spherical and/or ellipsoidal filler particles can have a diameter of between 10 μm and 50 μm. Phenolic resin beads, glass beads, PE or HDPE beads, such as Mipelon, can be as a material for the spherical or ellipsoidal particles. Glass beads, hollow glass beads and beads made of PEEK, phenolic resin and epoxy resin have a comparatively high resistance.

Fillers consisting of spherical or ellipsoidal particles make it easy to achieve a more uniform structure on the surface of the sealing body. For more solid geometries of the sealing body or sealing elements, particles with a larger diameter can also be used. Ellipsoidal particles can be characterized by a diameter-to-length ratio of between 1:1 and 1:10, preferably between 1:1.1 and 1:1:5.

Fibrous particles of the above-mentioned fillers with a diameter of 4 to 30 μm and a length of the fibers remaining in the compound after the mixing process of 50 to 1000 μm are considered advantageous. Glass, carbon and PTFE are particularly suitable due to their chemical inertness, as they exhibit a comparatively high resistance to lubricants. After abrasion of the thin elastomer layer, which is stretched over the filler particles arranged on the surface of the sealing body, a combination of hard fillers with fillers that have self-lubricating properties, such as PTFE, is particularly suitable, as they reduce friction even if the friction or contact surface between the sealing lip and the running plate increases as a result of abrasion.

In an example embodiment, the elastomer material of the seal is provided with 1.5% to 15%, in particular 3% to 7% of the first filler. The first filler can be carbon or carbon fibers.

In an example embodiment, the elastomer material is provided with 1.5% to 15%, in particular 1% to 4%, of the second filler. The second filler can be PTFE micropowder. This combination of the first and second filler in the seal allows for a friction-optimized, durable seal.

The third filler can be glass powder or phenolic resin particles. This combination of the first, second and third filler in the seal allows for a highly friction-optimized and durable seal.

Furthermore, the disclosure relates to a bearing comprising at least one outer ring and at least one inner ring. At least one seal arrangement is arranged spatially between the respective inner ring and the respective outer ring, and the seal arrangement has a sealing element which has a carrier with a sealing body molded thereon of an elastomer material. The sealing body has at least a first sealing lip, and the elastomer material of the sealing body is provided with fillers arranged therein at least in regions. The elastomer material has at least a first filler and a second filler, and particles of at least one of the fillers have a higher hardness than the elastomer material of the sealing body. A running plate is provided against which the sealing lip comes into sealing contact, and the carrier is arranged to be rotatable relative to the running plate, or vice versa. The seal arrangement can be used in cars, trucks and in all applications where seals are used under dynamic conditions, i.e., not only for sealing bearings.

The bearing can be a wheel bearing for a vehicle.

### BRIEF DESCRIPTION OF THE DRAWINGS

Further measures improving the disclosure, together with the description of two example embodiments of the disclosure, are described in greater detail below with reference to the figures, wherein identical or similar elements are provided with the same reference symbol. In the figures:

FIG. 1 shows a simplified schematic sectional view of a wheel bearing with two seal arrangements according to the disclosure,

FIG. 2 shows a schematic sectional view of the first seal arrangement according to a first example embodiment,

FIG. 3 shows a schematic sectional view of the second seal arrangement of the wheel bearing according to the first example embodiment,

FIG. 4 shows a schematic sectional view of the first seal arrangement according to a second example embodiment, and

FIG. 5 shows a schematic sectional view of the second seal arrangement according to the second example embodiment.

### DETAILED DESCRIPTION

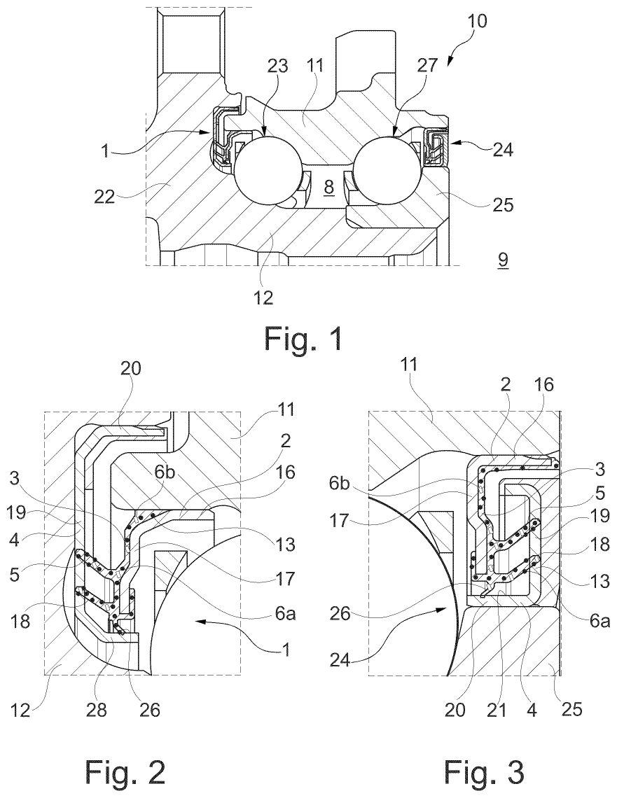

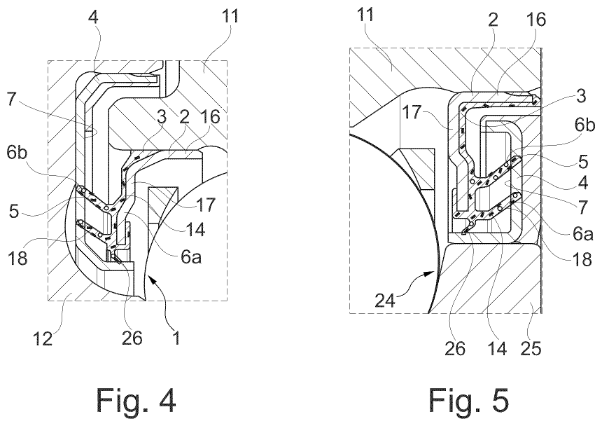

FIG. 1 shows an exemplary bearing 10, in this case a wheel bearing, for a vehicle—not shown here—comprising an outer ring 11 and two inner rings 12, 25. The first inner ring 12 is integrally connected to a wheel hub 22. When the first inner ring 12 is referred to below, this is to be understood as a flange of the wheel hub 22 on which a raceway is formed on which the rolling elements of a first row of rolling elements 23 of the bearing 10 roll. In contrast, the second inner ring 25 is pressed onto the wheel hub 22 for constructive reasons. Two rows of rolling elements 23, 27 are arranged spatially between the outer ring 11 and the inner rings 12, 25 in the present case. An interior 8 of the bearing 10 is furthermore sealed off from an outer region 9 by two sealing elements 1, 24. The detailed structure of the sealing elements 1, 24 is shown in more detail for the first example embodiment in FIGS. 2 and 3 and for the second example embodiment in FIGS. 4 and 5, wherein the sealing elements 1, 24 of the different embodiments differ only in the design of a sealing body 3. Each sealing element 1, 24 has a carrier 2 and a running plate 4, wherein the carrier 2 of the respective sealing element 1, 24 is arranged in a non-rotatable manner on the outer ring 11 and the running plate 4 of the respective sealing element 1, 24 is arranged in a non-rotatable manner on the first inner ring 12 or on the second inner ring 25. The carrier 2 is arranged such as to be rotatable relative to the running plate 4.

In the present case, the carrier 2 is designed in an L-shaped cross-section and has a substantially axial section 16 and a substantially radial section 17. The carrier 2 is pressed into the outer ring 11 with the axial section 16. The running plate 4 is designed in a C-shaped cross-section, wherein the respective running plate 4 is pressed with a first substantially axial leg 20 into the first inner ring 12 or pressed onto the second inner ring 25. As shown in FIG. 3 and FIG. 5, the running plate 4 can have a vulcanized coding ring—not described in detail here—which interacts with a sensor device—not shown here—in order to determine a rotational speed, for example.

A sealing body 3 is vulcanized onto the carrier 2 of the respective sealing element 1, 24, which has an elastically deformable first, second and third sealing lip 5, 18, 26, each of which extends at an angle from the sealing body 3 in the direction of the running plate 4. The first and second sealing lips 5, 18 come into sealing contact with a first counter-running surface 7 on a radial leg 19 of the running plate 4. Regarding the first sealing element 1 shown in FIGS. 2 and 4, the third sealing lip 26 comes into sealing contact with a second counter-running surface 21 on a second substantially axial leg 28 of the running plate 4. Regarding the second sealing element 24 shown in FIGS. 3 and 5, the third sealing lip 26 comes into sealing contact with a second counter-running surface 21 on the first substantially axial leg 20 of the running plate 4.

The sealing body 3 is designed as a sealing ring made of an elastomer material, such as NBR, with fillers 6a, 6b arranged therein. In this regard, the elastomer material is formed with a combination of at least two different fillers 6a, 6b.

The first filler 6a has substantially spherical particles 13 in the first example embodiment according to FIGS. 1 to 3 and substantially fibrous particles 14 in the second example embodiment according to FIGS. 4 and 5. The fillers 6a, 6b are arranged in a homogeneously distributed manner throughout the elastomer material of the sealing body 3, wherein some of the particles 13, 14 are arranged on the surface of the sealing body 3, in particular on the sealing lips 5, 18, 26 coming into contact with the running plate 4. The fillers 6a, 6b have a higher hardness than the elastomer material of the sealing body 3 and, where they are arranged on the surface 15, have the effect of structuring the surface 15 of the sealing body 3. Due to the geometric shape and the material-specific properties of the particles 13, 14 of the fillers 6a, 6b, the structuring in the surface 15 reduces friction in the sealing lip contact with the running plate 4, which reduces torques in the bearing 10.

According to FIGS. 2 and 3, the particles 13 of the first filler 6a, 6b are designed to be spherical. The spherical particles 13 can be made of plastic, an elastomer, glass, carbon or ceramic. It is also possible to design all or part of the particles 13 to be ellipsoidal. The first filler 6a can be mixed into the sealing body 3 with a higher percentage than the second filler 6b. In an example embodiment, first filler 6a can be made up of carbon fibers. These are mixed into the elastomer material of the sealing body 3, preferably with 1.5% to 15%, particularly preferably with 3% to 7%. The second filler 6b, which is different from the first filler, can have a different geometric shape.

In FIGS. 2 and 3, the second filler 6b is designed to be fibrous. The second filler 6b can be made up of a PTFE micropowder, glass powder or phenolic resin beads. The second filler 6b can be mixed into the elastomer material of the sealing body 3 with 1.5% to 15%, particularly preferably with 1% to 4%. A combination of two different fillers 6a, 6b is thus added to the sealing body 3, which can reduce both friction and abrasion on the seal.

According to FIGS. 4 and 5, the particles 14 of the first filler 6a are designed to be fibrous. The fibrous particles 14 can be made up of carbon fibers, a plastic, an elastomer, glass, ceramic or a mixture of the aforementioned. Carbon fibers are chemically inert so that an improved chemical compatibility of the respective sealing element 1, 24 can be achieved. In this exemplary embodiment, the particles of the second filler 6b are designed to be spherical. In this exemplary embodiment, the sealing body 3 consists of an elastomer material, such as NBR, mixed with 1.5% to 15% of the first filler 6a, in particular carbon fibers, and with 1.5% to 15% of a second filler 6b, preferably PTFE micropowder, glass powder or phenolic resin beads.

It would also be conceivable to provide the elastomer material of the sealing body 3 with a first, a second and a third filler. The third filler can be made up of PTFE micropowder, glass powder or phenolic resin beads.

### LIST OF REFERENCE SYMBOLS

1 First sealing element
2 Carrier
3 Sealing body
4 Running plate
5 First sealing lip
6a First filler
6b Second filler
7 First counter-running surface
8 Interior
9 Outer region
10 Bearing
11 Outer ring
12 First inner ring
13 Spherical particles
14 Fibrous particles
15 Surface
16 Axial section of the carrier plate
17 Radial section of the carrier plate
18 Second sealing lip
19 Radial leg of the running plate
20 First axial leg of the running plate
21 Second counter-running surface
22 Wheel hub
23 First row of rolling elements
24 Second sealing element
25 Second inner ring
26 Third sealing lip
27 Second row of rolling elements
28 Second axial leg of the running plate

1. A seal arrangement with a sealing element which has a carrier plate with a sealing body molded thereon of an elastomer material, the sealing body having at least a first sealing lip, and the elastomer material has at least a first filler and a second filler different from the first filler, wherein particles of at least one of the first filler or the second filler has a higher hardness than the elastomer material of the sealing body.

2. The seal arrangement according to claim 1, wherein the first filler is made of carbon.

3. The seal arrangement according to claim 2, wherein the second filler is made of PTFE micropowder.

4. The seal arrangement according to claim 1, wherein the elastomer material comprises particles of a third filler made of glass powder or phenolic resin.

5. The seal arrangement according to claim 1, wherein the elastomer material is made of a vulcanized rubber.

6. The seal arrangement according to claim 1, characterized in that the particles of the first filler and the particles of the second filler have different geometric shapes.

7. The seal arrangement according to claim 6, wherein the particles of the first filler are spherical or ellipsoidal and the particles of the second filler are fibrous.

8. The seal arrangement according to claim 1, wherein the elastomer material is provided with 1.5% to 15% of the first filler.

9. The seal arrangement according to claim 8, wherein the elastomer material is provided with 1.5% to 15 of the second filler.

10. A bearing, comprising:
at least one outer ring,
at least one inner ring,
at least one seal arrangement according to claim 1 arranged spatially between the at least one inner ring and the at least one outer ring,
a running plate sealingly contacting the first sealing lip, and
one of the carrier plate or the running plate arranged to be rotatable relative to a remaining one of carrier plate or the running plate.

11. The seal arrangement according to claim 1, further comprising a second sealing lip.

12. The seal arrangement according to claim 11, further comprising a third sealing lip.

13. The seal arrangement according to claim 12, wherein the first sealing lip and the second sealing lip extend axially, and the third sealing lip extends radially.

14. The seal arrangement according to claim 1, wherein the elastomer material is provided with 3% to 7% of the first filler.

15. The seal arrangement according to claim 14, wherein the elastomer material is provided with 1% to 4% of the second filler.

16. The seal arrangement according to claim 2, wherein the second filler is made of glass powder.

17. The seal arrangement according to claim 2, wherein the second filler is made of phenolic resin.

18. The seal arrangement according to claim 6, wherein the particles of the first filler are fibrous and the particles of the second filler are spherical or ellipsoidal.

19. A bearing, comprising:
an outer ring,
an inner ring,
a plurality of rolling elements disposed between the inner ring and the outer ring,
a seal arrangement disposed between the inner ring and the outer ring, the seal arrangement comprising:
a carrier plate fixed to the outer ring, the carrier plate having a molded body thereon, the molded body comprising at least one elastically deformable sealing lip formed integrally with the molded body, and
the molded body and the elastically deformable sealing lip constructed from an elastomer material having a first filler, a second filler, and a third filler, and
a running plate:
sealingly contacting the at least one elastically deformable sealing lip,
fixed to the inner ring, and
wherein:
the first filler, the second filler, and the third filler are different from each other,
the first filler comprises carbon,
the second filler comprises glass, phenolic resin, or PTFE, and
the third filler comprises glass, phenolic resin, or PTFE.

20. The bearing of claim 19, wherein the carrier plate is L-shaped and the at least one elastically deformable sealing lip extends axially from a radially extending section of the carrier plate.
